(19) United States
(12) Patent Application Publication
(10) Pub. No.: US 2022/0099914 A1
(43) Pub. Date: Mar. 31, 2022

(54) OPTICAL DEVICE COMPRISING PASSIVE TEMPERATURE COMPENSATION

(71) Applicant: OPTOTUNE AG, Dietikon (CH)

(72) Inventors: Manuel ASCHWANDEN, Allenwinden (CH); Roman PATSCHEIDER, Winterthur (CH); Stephan SMOLKA, Zürich (CH); Christopher LANING, Windisch (CH)

(73) Assignee: OPTOTUNE AG, Dietikon (CH)

(21) Appl. No.: 17/420,688

(22) PCT Filed: Jan. 8, 2020
(86) PCT No.: PCT/EP2020/050338

§ 371 Date: Jul. 5, 2021

(30) Foreign Application Priority Data
Jan. 8, 2019 (EP) 19150839.9

(51) Int. Cl. G02B 7/02; G02B 3/14

(52) U.S. Cl. CPC G02B 7/028; G02B 3/14

(57) ABSTRACT

An optical device (1), comprising: a first refractive element (10) configured to refract incoming light (L), wherein the first refractive element (10) comprises a first refractive index (n₁(T)) and a first surface S₁(T) for receiving a wavefront (W) of said incoming light, a second refractive element (11) configured to refract light coming from the first refractive element (10), wherein the second refractive element (11) is arranged adjacent the first refractive element (10) such that a second surface (S₂(T)) is formed between the first refractive element (10) and the second refractive element (11), via which second surface (S₂(T)) light can pass from the first refractive element (10) to the second refractive element (11), and wherein the second refractive element (11) comprises a second refractive index (n₂(T)) and a third surface (S₃(T)) for transmitting light coming from the first refractive element (10) and passing through the second refractive element (11), and wherein the refractive indices (n₁(T), n₂(T)) and the shapes of the surfaces (S₁(T), S₂(T), S₃(T)) are adapted such that a shape of a wavefront (W′) of the transmitted light is independent of a temperature of the optical device, when said temperature (T) lies within a pre-defined temperature range.

The present invention relates to an optical device, particularly a lens, particularly a liquid lens, particularly a liquid lens having an adjustable focal power (the focal power is the reciprocal value of the focal length of the lens) and/or an adjustable surface form.

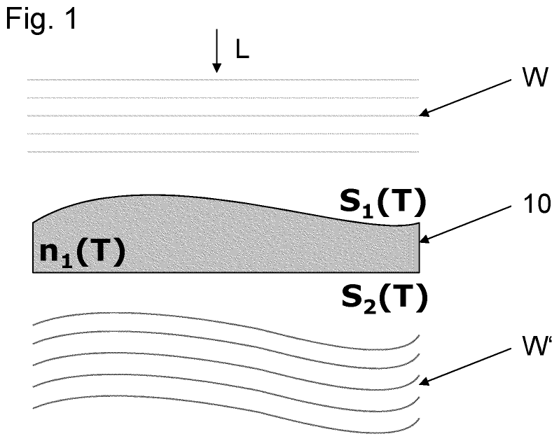

Generally, an optical device that comprise a refractive element (cf. e.g. FIG. 1) that is configured to refract light that passes the refractive element (e.g. a lens) 10 may have the disadvantage that a transmitted wavefront W′ changes with a temperature T of the refractive element 10, due to the fact that a refractive index n₁ of the refractive element (i.e. of its material) 10 as well as the shapes of two opposing surfaces S₁(T), S₂(T) of the refractive element 10 via which surfaces the light/incoming wavefront W passes the refractive element 10 change with temperature T. Thus, such a refractive element 10 undergoes unfavorable thermally induced changes of its refractive property.

Therefore, it is an objective of the present invention to provide an optical element that is capable of generating a transmitted wavefront that is temperature-independent and thus does not undergo thermally induced changes.

This problem is solved by an optical device having the features of claim 1.

Preferred embodiments of this optical device are stated in the sub claims and are described below.

According to claim 1, an optical device is disclosed comprising:
a first refractive element configured to refract incoming light, wherein the first refractive element comprises a first refractive index and a first surface for receiving a wavefront of said incoming light,
a second refractive element configured to refract light coming from the first refractive element, wherein the second refractive element is arranged adjacent the first refractive element such that a second surface is formed between the first refractive element and the second refractive element, via which second surface light can pass from the first refractive element to the second refractive element, and wherein the second refractive element comprises a second refractive index and a third surface for transmitting light coming from the first refractive element and passing through the second refractive element, and
wherein the refractive indices and the shapes of the surfaces are selected such that a shape of a wavefront of the transmitted light is independent of a temperature of the optical device (e.g. for a pre-defined wavefront or focal power of the optical device), particularly when said temperature lies within a pre-defined temperature range.

For the purposes of designing the optical device, said temperature can be assumed to be constant though out the lens (e.g. due to a thermal equilibrium). However, when operating the optical device, the latter may also exhibit a temperature gradient, i.e. a temperature distribution.

According to an embodiment, said temperature range corresponds to temperatures from −40° C. to 85° C., particularly to temperatures from 0° C. to 65° C.

According to an embodiment of the present invention, for adapting the first refractive index, the first refractive element is formed out of a corresponding transparent first material, and wherein for adapting the second refractive index, the second refractive element is formed out of a corresponding transparent second material.

Further, according to an embodiment of the present invention, the first refractive index and the shape of the first surface depend on the temperature due to the thermal expansion of the optical device (e.g. induced by an increasing temperature). Here, particularly, the first and second material may be selected such that the temperature dependence of the second refractive index and the shapes of the second and third surfaces are negligible compared to the first refractive index and the first surface shape and can therefore be disregarded.

Further, according to an embodiment of the present invention, the second refractive index and the shapes of the second surface and of the third surface each depend on the temperature (e.g. to a similar degree as the first refractive index and the first surface).

Further, according to an embodiment of the present invention, the first and the second refraction index can also depend on the wavelength of the incoming light, i.e., the first material and the second material cause said refraction indices to also depend on the wavelength of the incoming light.

Furthermore, according to an embodiment of the present invention, the refractive indices and the shapes of the surfaces are selected such that a shape of a wavefront of the transmitted light is independent of the temperature and a chromatic aberration of the two refractive elements is reduced (e.g. relative to a refractive system with only one material) or prevented, when the temperature lies within the pre-defined temperature range.

According to a further embodiment of the present invention, the second surface comprises a curved shape.

Further, according to an embodiment of the present invention, the two refractive elements form a lens having a tunable focal length, wherein the first refractive element comprises a transparent liquid arranged between the first surface and the second surface, wherein the first surface is elastically deformable and comprises a shape having a tunable first radius depending on temperature (since the volume of the liquid changes with temperature), and wherein the second refractive element is rigid and forms the second surface which comprises a shape having a second radius, and wherein the third surface comprises one of a planar shape, a concave shape, a convex shape.

According to an embodiment, the shape of the first surface comprises a spherical and/or a cylindrical component. Further, the shape of the first surface can be one of: spherical, cylindrical.

Furthermore, according to an embodiment, the shape of the second surface can comprise a spherical and/or a cylindrical component.

Further, particularly the shape of the second surface can be one of: spherical, cylindrical, or may comprise a more complex geometry (e.g. may comprise components other than spherical or cylindrical components). For instance, the second surface can include a conical portion or conical component.

Further, according to an embodiment of the present invention, for a given first refractive index, a given temperature-dependent first radius, and a planar wavefront of the incoming light, the second refractive index, the second radius and the third surface shape (e.g. third radius) are selected such that the wavefront of the transmitted light is independent of the temperature when the temperature is within the pre-defined range.

Further, according to an embodiment of the present invention, the first refractive index exhibits a more pronounced temperature dependence than the second refractive index, i.e. the magnitude of the variations of the first refractive index with temperature are larger than those of the second refractive index.

Particularly, the first material comprises a general volumetric thermal expansion coefficient αᵥ=(1/V)·(∂V/∂T)_{P} that is larger than the general volumetric thermal expansion coefficient of the second material.

Further, according to an embodiment of the present invention, the first refractive index is lower than the second refractive index.

Further, according to an embodiment of the present invention, the liquid comprises a lower dispersion than the second refractive element.

Further, according to an embodiment of the present invention, the lens forms an achromat.

Furthermore, according to an embodiment of the present invention, the second surface comprises a flat annular boundary portion having an outer diameter, wherein the boundary portion surrounds a central concave portion having a diameter that is smaller than said outer diameter.

Particularly, the outer diameter corresponds to a diameter of at least one of: the first surface, the second surface, the third surface.

According to a further embodiment, the optical device comprises a lens shaper contacting a transparent and elastically deformable membrane of the optical device, wherein the first surface is formed by a central portion of a surface of the membrane, wherein said central portion of the surface of the membrane is defined by the lens shaper. For this, the lens shaper comprises a circumferential edge from which said central portion protrudes. In this way, the lens shaper delimits said central portion of the membrane. The curvature of this central portion and therewith the focal power of the lens can be adjusted by pushing against the membrane with the lens shaper or by pulling on the membrane. Due to the liquid the central portion can thus be given a convex shape, e.g. by pushing with the lens shaper against the membrane, or a concave shape, e.g. by pulling on the membrane with the lens shaper.

Furthermore, according to an embodiment, the actuator is configured to act on the membrane to tune the first radius (or curvature of said central portion of the membrane).

According to a further embodiment, the actuator is configured to move a mover of the actuator along an optical axis of the optical device, wherein the mover is connected via a connecting structure to the lens shaper to move the lens shaper along the optical axis to adjust the first radius of the first surface and therewith the focal power of the optical device.

Particularly, in an embodiment, the actuator comprises a stationary magnet and a mover, wherein the mover comprises an electrical coil for generating a magnetic field to interact with a magnetic field of the magnet so that the mover is moved along the optical axis.

In the following embodiments as well as features and advantages of the present invention are described with reference to the Figures, wherein

FIG. 1 shows a schematical cross sectional view of a refractive element having a first and an opposing second surface;

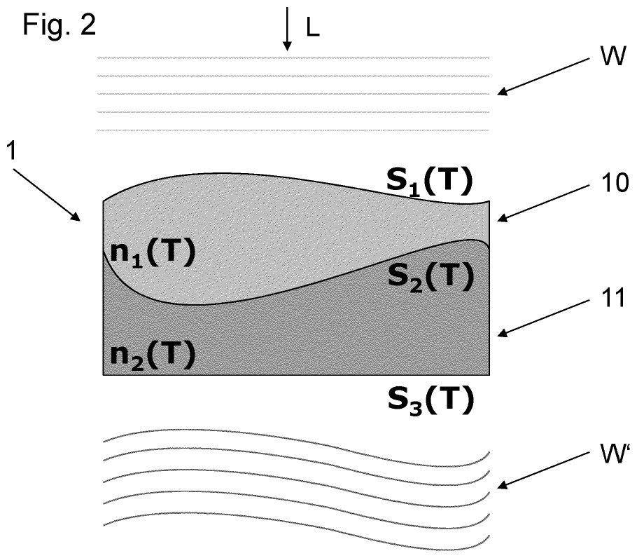

FIG. 2 shows a schematical cross sectional view of an embodiment of an optical device according to the present invention;

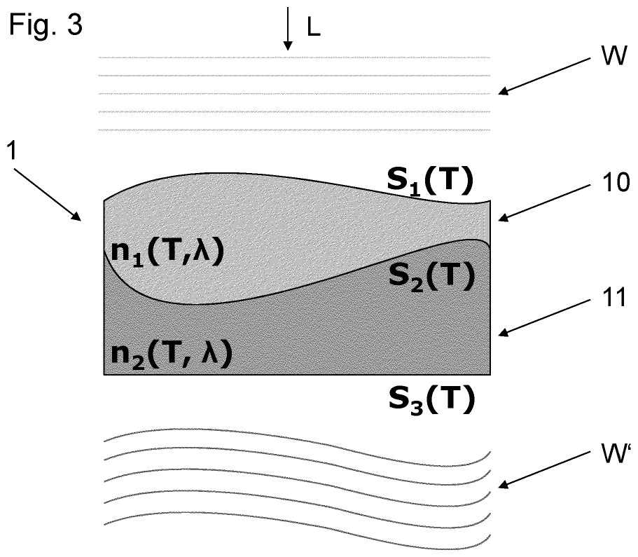

FIG. 3 shows a schematical cross sectional view of a further embodiment of an optical device according to the present invention;

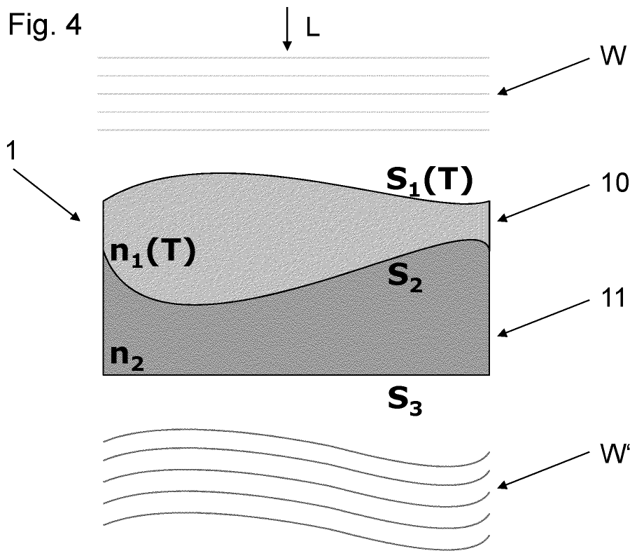

FIG. 4 shows a schematical cross sectional view of a further embodiment of an optical device according to the present invention;

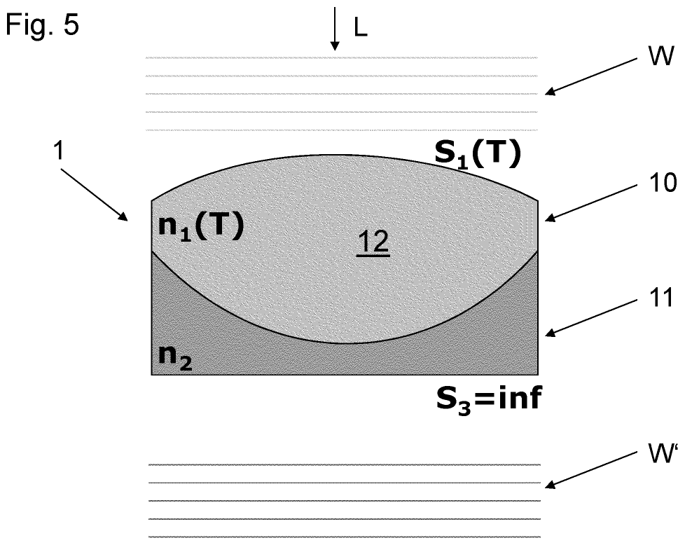

FIG. 5 shows a schematical cross sectional view of a further embodiment of an optical device according to the present invention;

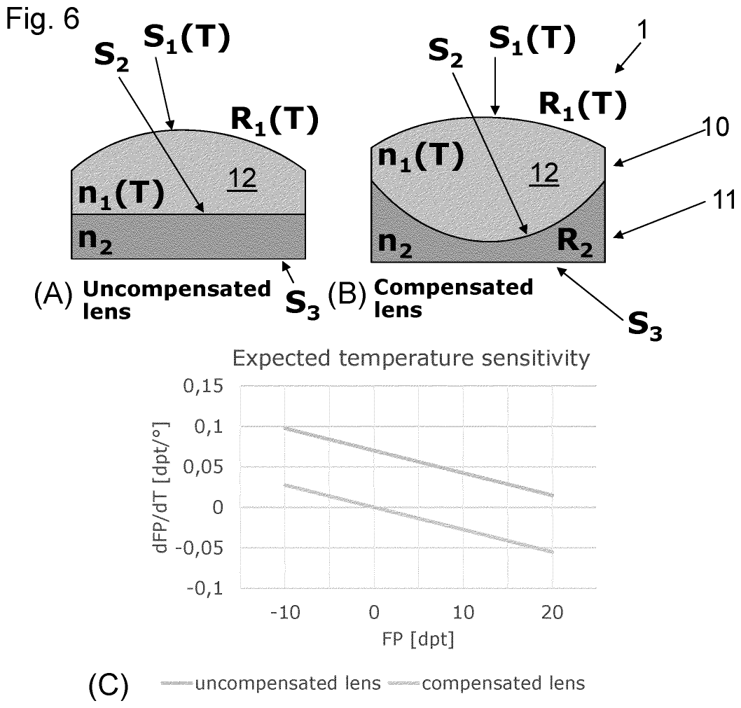

FIG. 6 shows an embodiment of an optical device according to the present invention in form of a lens (B) compared to an uncompensated lens (A), wherein (C) shows the expected temperature sensitivity of the lenses;

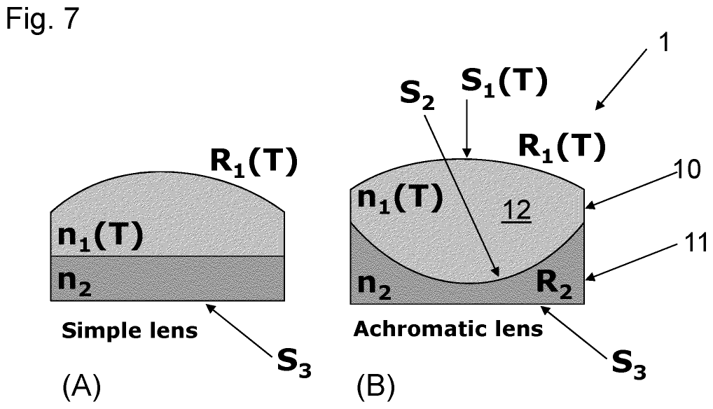

FIG. 7 shows an embodiment of an optical device according to the present invention in form of a lens forming an achromat (B) compared to an uncompensated lens (A) having chromatic aberrations;

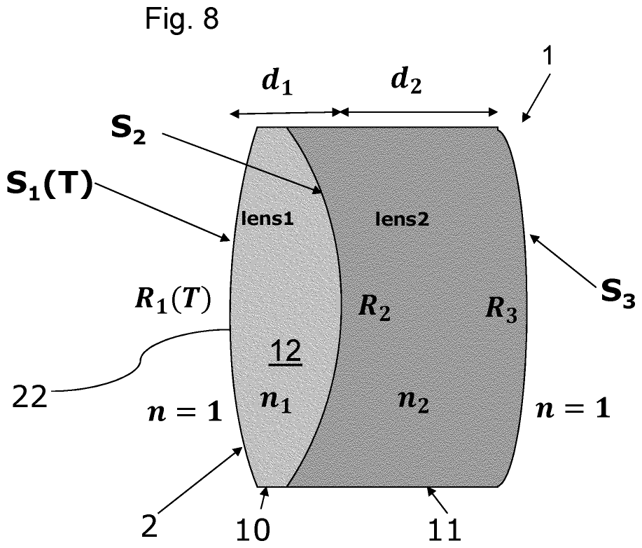

FIG. 8 shows an embodiment of an optical device (e.g. a lens) according to the present invention, wherein here the temperature dependence of the refractive indices n₁,n₂ and of the radii R₂, R₃ is disregarded compared to the dominant temperature dependence of the first radius R₁;

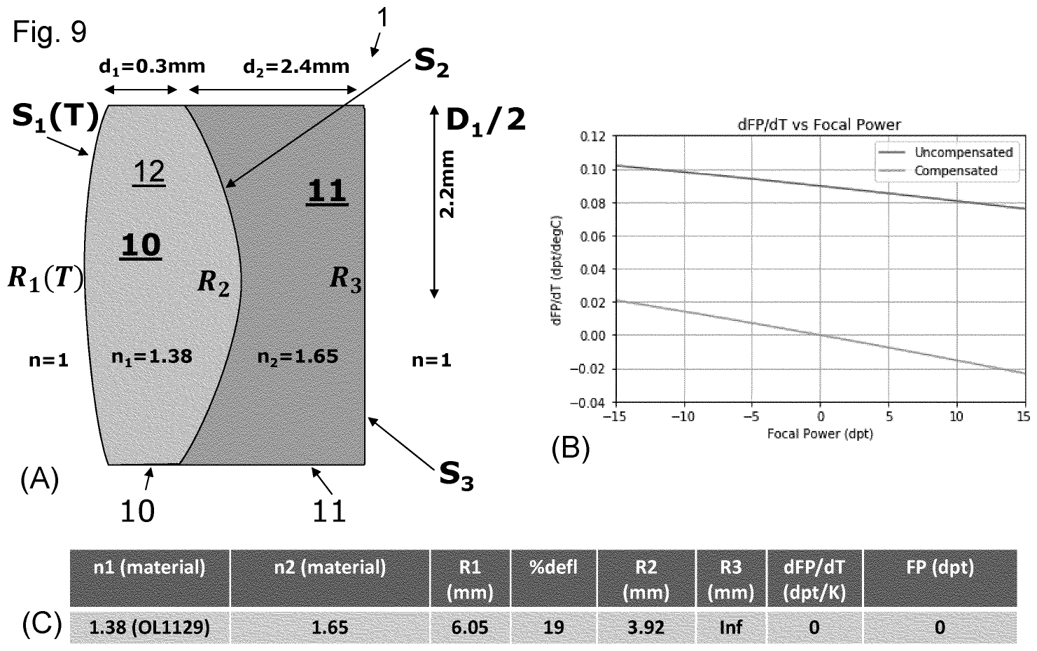

FIG. 9 shows an embodiment of an optical device (e.g. a lens) according to the present invention comprising a rigid plano-concave second refractive element;

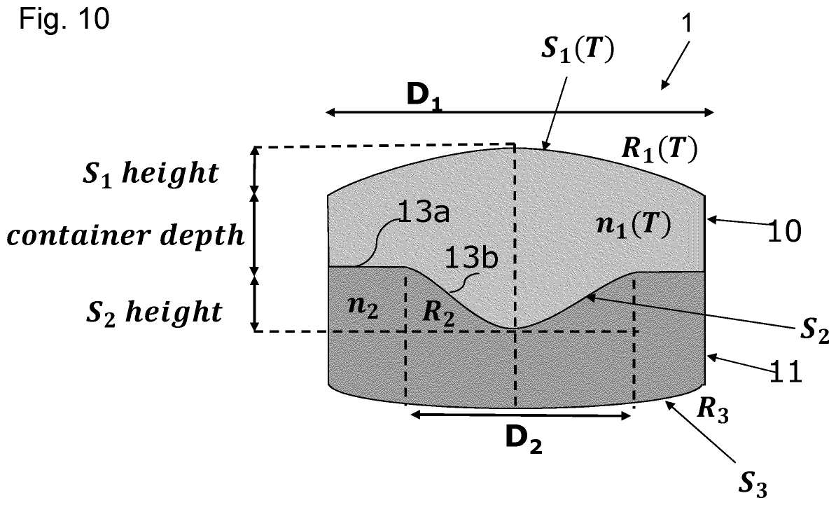

FIG. 10 shows an embodiment optical device (e.g. a lens) according to the present invention, wherein the second surface comprises a flat annular boundary portion that surrounds a central concave portion of the second surface;

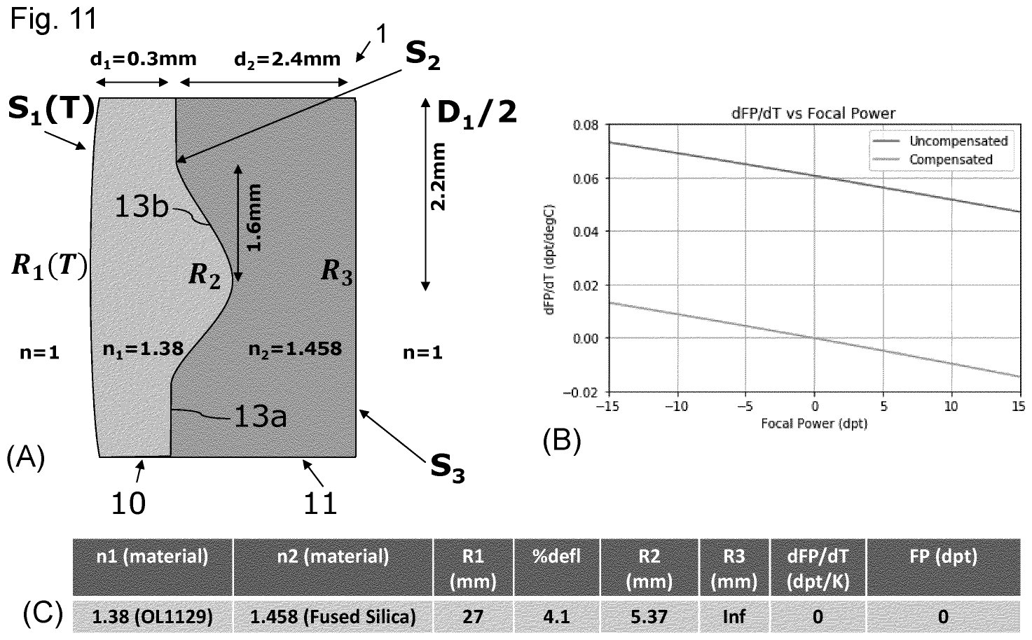

FIG. 11 shows an embodiment comprising the configuration according to FIG. 10, wherein the optical device comprises a planar third surface and a convex first surface;

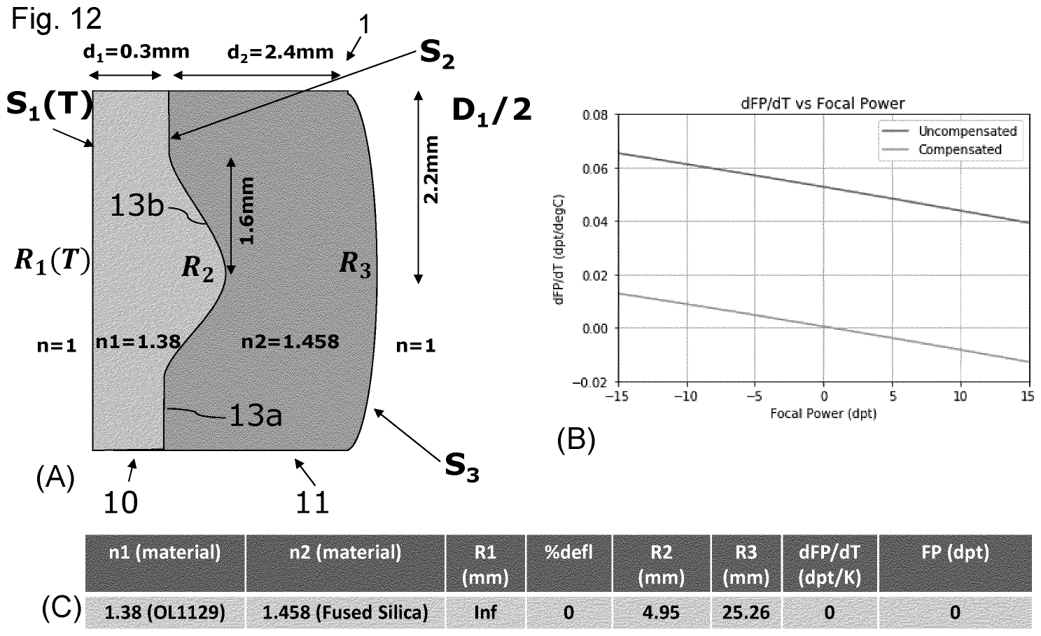

FIG. 12 shows an embodiment comprising the configuration according to FIG. 10, wherein the optical device comprises a convex third surface and a flat first surface; and

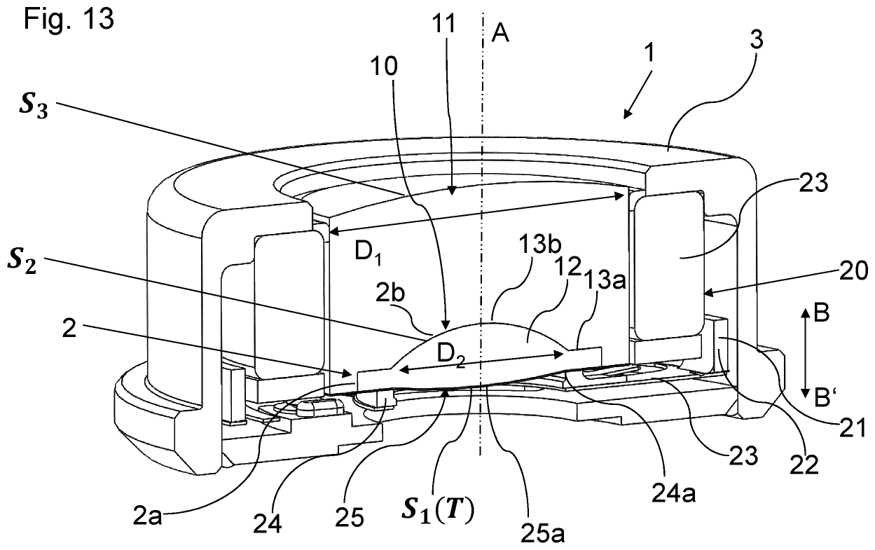

FIG. 13 shows an embodiment of an optical device according to the present invention in form of a lens 1 having an adjustable focal power (or focal length), wherein preferably the lens comprises a configuration as shown in FIG. 10.

FIG. 1 shows a schematical cross sectional view of a refractive element 10 as known in the state of the art having a first and an opposing second surface S₁, S₂, The surfaces S₁, S₂ each comprise a shape that depends on temperature (e.g. due to a temperature dependence of the volume of the underlying material). Therefore, an incoming wavefront W of incident light L generates a transmitted wavefront leaving the second surface S₂ that comprises a shape that depends on the temperature T of the refractive element 10.

FIG. 2 shows a schematical cross sectional view illustrating the principle of the present invention. According thereto, the optical device comprises a first refractive element 10 configured to refract incoming light L, wherein the first refractive element 10 comprises a first refractive index n₁(T) and a first surface S₁(T) for receiving a wavefront W (e.g. constant, particularly planar) of said incoming light. The device 1 further comprises a second refractive element 11 configured to refract light coming from the first refractive element 10, wherein the second refractive element 11 is arranged adjacent the first refractive element 10 such that a second surface S₂(T) is formed between the first refractive element 10 and the second refractive element 11, via which second surface S₂(T) light can pass from the first refractive element 10 to the second refractive element 11. Furthermore, the second refractive element 11 comprises a second refractive index n₂(T) and a third surface S₃(T) for transmitting light coming from the first refractive element 10 and passing through the second refractive element 11. Now, according to the present invention, the refractive indices n₁(T), n₂(T) and the shapes of the surfaces S₁(T), S₂(T), S₃(T) particularly depend on the temperature T of the refractive elements 10, 11 and are adapted such that a shape of a wavefront W′ of the transmitted light is independent of the temperature T, when said temperature T lies within a pre-defined temperature range.

In other words, according to the present invention, a combination of n₁(T), n₂(T), S₁(T), S₂(T) and S₃(T) can be found that makes the transmitted wavefront W′ temperature independent.

FIG. 3 shows a further embodiment of an optical device 1 comprising the components described in conjunction with FIG. 2, wherein here the the refractive indices n₁(T, λ), n₂(T, λ) also depend on the wavelength of the light L impinging on the device 1.

Here, n₁(T, λ), n₂(T, λ), S₁(T), S₂(T) and S₃(T) are selected such that the transmitted wavefront W′ is rendered temperature independent, wherein furthermore a dependence of the transmitted wavefront W′ on the on wavelength is reduced or vanishes (e.g. the device 1 forms an achromat)

FIG. 4 shows a further modification of the embodiment shown in FIG. 2, wherein here the temperature dependence of the second refractive index n₂(T) and of the shapes of the second and third surfaces S₂, S₃ can be neglected.

Given the first refractive index n₁(T) and the first surface S₁(T), a second refractive index n₂, and a second and a third surface S₂ and S₃ can be selected to make the transmitted wavefront W′ temperature independent.

Furthermore, FIG. 5 shows an application example of the present invention, wherein also here an wavefront W (e.g. constant, particularly planar) is incident on the first surface S₁ of the first refractive element 10 of the device 10, wherein the first surface S₁(T) is a flexible spherical surface comprising a tunable radius R₁. The first surface (T) delimits a transparent liquid 12 of the first refractive element 10, wherein due to a thermal expansion of the liquid 12, the first radius R₁(T) is a function of the temperature T of the liquid 12/first refractive element 10.

The liquid 12 is further delimited by the opposing second surface S₂, which is a surface of the rigid second refractive element 11, wherein this second surface S₂ comprises a fixed radius R₂ so that the liquid 12 forms a bi-convex volume in FIG. 5. The third surface S₃ of the second refractive element 11 is a planar surface S₃.

Given the first refractive index n₁(T) and the first radius R₁(T) as functions of temperature T, the second refractive index n₂ and the second radius R₂ are selected according to the present invention such that the transmitted wavefront W′ is still planar like the incident wavefront W and temperature independent.

Here, in this embodiment, the first refractive index n₁(T) preferably comprises a strong temperature dependence and particularly a low dispersion (e.g. transparent optical liquid 12 such as a liquid polymer, particularly a silicone oil). Furthermore, the second refractive index n₂ (compared to the first refractive index) preferably comprises a weak temperature dependence and particularly a high dispersion (e.g. a glass).

Particularly, the concept of the present invention is insensitive to the absolute magnitude of the refractive indices of the materials, and is sensitive only to the relative change of the refractive indices with temperature. Thus, according to a preferred embodiment, both the first and the second material can have the same refractive indices (e.g. at the nominal design temperature). Furthermore, according to a preferred embodiment a high refractive index is selected for the liquid so that the curvatures of the first surface S₁(T) can be reduced.

FIG. 6(B) shows an embodiment of the device 1 shown in FIG. 5, wherein here the optical device 1 forms a lens comprising a transparent and rigid (e.g. glass) window 11 (second refractive element), a liquid filled container 10 (first refractive element) and a membrane forming the deformable surface S₁, wherein the lens 1 allows tuning the first radius R₁ (e.g. by means of an actuator). Here, the second surface and the third surface S₂, S₃ are formed by the window 11.

Particularly, a thermal expansion of the liquid 12 causes a change in the first radius R₁, wherein here e.g. dR₁/dT<0.

Furthermore, the first refractive index nᵢ of the liquid 12 is also temperature dependent, wherein here e.g. dn₁/dT<0.

R₂ and R₁ can now be chosen such that the lens 1 is fully temperature compensated for a selected focal power (dFP/dT|_{FP=0}=0) compared to a conventional lens shown in FIG. 6(A) (cf. FIG. 6(C)). Particularly, dFP/dT|_{Fp=0} can be achieved for any selected focal power of the lens 1. The focal power (also denoted as optical power) corresponds to the reciprocal value of the focal length.

Furthermore, as indicated in FIG. 7(B), the refractive material 12 (e.g. optical liquid 12) can be given a low refractive index and a low dispersion, while the refractive material 11 (e.g. window, particularly glass) can be given a high refractive index and high dispersion so that the combination forms an achromatic doublet compared to the standard lens shown on the left hand side (e.g. FIG. 7(A)).

To demonstrate specific examples of the present invention, FIG. 8 shows a configuration of an optical device 1 (e.g. a lens) according to the present invention, wherein here the temperature dependence of the refractive indices n₁,n₂ and of the radii R₂, R₃ is disregarded compared to the dominant temperature dependence of the first radius R₁. Such an approach is particularly justified when the first refractive element 10 is formed by a liquid 12. Particularly, as will be described in more detail in conjunction with FIG. 13 below, the liquid 12 is enclosed by a container 2, wherein at least a portion of a surface of a transparent and elastically deformable membrane 25 of said container 2 forms the first surface S₁.

Using the formula for thick lenses in air (n=1), the focal powers for the respective refractive elements 10, 11 can be calculated according to

$${FP}_{l e n s 1} = ( {n}_{1} - 1 ) * ( \frac{1}{{R}_{1}} - \frac{1}{{R}_{2}} + \frac{( {n}_{1} - 1 ) {d}_{1}}{{n}_{1} {R}_{1} {R}_{2}} )$$

$${FP}_{l e n s 2} = ( {n}_{2} - 1 ) * ( \frac{1}{{R}_{2}} - \frac{1}{{R}_{3}} + \frac{( {n}_{2} - 1 ) {d}_{2}}{{n}_{2} {R}_{2} {R}_{3}} )$$

wherein d₁ and d₂ are the thicknesses of the elements 10, 11 in the direction of the optical axis A of the lens 1 at the location of the optical axis A (i.e. center of the respective element 10, 11).

The total focal power thus amounts to

FP_{Total}=FPₗₑₙₛ₁+FPₗₑₙₛ₂

And a drift of the total focal power due to a temperature drift from T₀ to T₁ amounts to

LFP=FP_{Total}(T₁)−FP_{Total}(T₀)

Using the this formula, the radii R₁, R₂, R₃ and the indices n₁, n₂ can be chosen such (at temperature Tₒ) that at a given total focal power, the drift of the total focal power due to a changing temperature (e.g. from T₀ to T₁) is zero, which is shown in the specific example depicted in FIG. 9(A) for a rigid plano-concave second refractive element 11 (i.e. R₃ is infinite) and a first refractive element 10 formed by a container filled 2 with a transparent liquid 12 (e.g. a liquid polymer such as a silicone oil) that is arranged between the membrane 22 and the second surface S₂ formed by the rigid second refractive element 11. Particularly, a typical centering point can be T₀=30° C.

According to FIGS. 9(B) and (C) at a total focal power equal to zero, the first refractive index is selected to be n₁=1.38 and the second refractive index is selected to be n₂=1.65, while the radii are selected as R₁=6.05 mm, R₂=3.92 mm and R₃=Inf. This selection of parameters achieves temperature independence of the chosen focal power as shown in the lower graph of FIG. 9(C). The upper graph indicates the dependency of temperature in case of an uncompensated lens.

Furthermore, according to the embodiment shown in FIG. 10 the second surface S₂ comprises a flat annular boundary portion 13a having an outer diameter D₁, wherein the boundary portion 13a is connected to and surrounds a central concave portion 13b of the second surface S₂, wherein said central portion 13b comprises a diameter D₂ that is smaller than said outer diameter D₁. wherein here the outer diameter D₁ corresponds to the diameters of said surfaces S₁, S₂, and S₃.

FIGS. 11 and 12 now show specific temperature compensated configurations using the lens geometry shown in FIG. 10.

Particularly, in the example depicted in FIG. 11(A), the lens 1 comprises a planar third surface S₃ (i.e. R₃=Inf.) and a convex first surface S₁, wherein according to FIGS. 11(B) and (C), at a total focal power equal to zero, the first refractive index is selected to be n₁=1.38 and the second refractive index is selected to be n₂=1.458 (here the second material is fused silica), while the radii are selected as R₁=27 mm, R₂=5.37 mm and R₃=Inf. This selection of parameters achieves temperature independence of the chosen focal power as shown in the lower graph of FIG. 11(C). The upper graph indicates the dependency of temperature in case of an uncompensated lens.

Furthermore, according to FIG. 12, temperature compensation is achieved for a configuration in which the first surface S₁ is flat and the third surface S₃ comprises a convex shape.

According to FIGS. 12(B) and (C) at a total focal power equal to zero, the first refractive index is selected to be n₁=1.38 and the second refractive index is selected to be n₂=1.458 (here the second material is fused silica), while the radii are selected as R₁=Inf., R₂=4.95 mm and R₃=25.26 mm. This selection of parameters achieves temperature independence of the chosen focal power as shown in the lower graph of FIG. 12(C). The upper graph indicates the dependency of temperature in case of an uncompensated lens.

Furthermore, FIG. 13 shows an embodiment of an optical device according to the present invention in form of a lens 1 having an adjustable focal power (or focal length), wherein particularly the lens 1 comprises a configuration as shown in FIG. 10.

Here, the first refractive element 10 is formed by a container 2 filled with a transparent liquid 12 (first material) wherein the container 2 comprises a circumferential lateral wall 2a as well as a bottom 2b formed by a second rigid refractive element 11 that forms a convex third surface S₃ and an opposing second surface S₂ forming said bottom 2c of the container 2. Particularly, said second surface S₂ comprises a central concave portion 13b surrounded by an annular flat portion 13a, wherein a diameter D₂ of said concave portion 13b is smaller than a diameter D₁ of the third surface S₃. The container 2 is closes by a transparent and elastically deformable membrane 25 which opposes the bottom 2c of the container 2.

The second refractive element 11 is formed out of a transparent second solid material such as a glass or plastic material (e.g. polymer).

Particularly, the lens 1 comprises a passive temperature compensation according to the present invention, e.g., given the tuneable first radius R₁(T), the refractive indices n₁, n₂ and the shapes of the remaining second and third surfaces are selected such that for a given focal power the focal power becomes independent of the temperature as shown e.g. in FIGS. 11(C) and 12(C).

In order to adjust the focal power of the lens 1, the latter comprises an actuator 20 that is configured to move a lens shaper 24 that contacts said membrane 25, wherein the first surface S₁ of the lens having the first radius R₁ is formed by a central portion of a surface 25a of the membrane 25, wherein said portion of the surface 25a of the membrane 25 is defined by the lens shaper 24, i.e. extends up to a circumferential inner edge 24a of the lens shaper 24.

Particularly, according to an embodiment, the actuator 20 can be configured to move a mover 22 of the actuator 20 along an optical axis A of the optical device 1, wherein the mover 22 is connected via a connecting structure 23 to the lens shaper 24 to move the lens shaper 24 along the optical axis A (i.e. in direction B or opposite direction B′) to adjust the first radius R₁ of the first surface S₁ and therewith the focal power of the optical device 1. This is due to the fact, that the container 2 is filled with the liquid 12, which causes the first surface S1 to bulge outwards when the lens shaper 24 is moved in direction B which in turn increases the focal power (since R₁ decreases). In case the lens shaper 24 is moved in the opposite direction B′. the focal power decreases correspondingly.

Particularly, the mover 22 can comprise a an electrical coil 21, wherein the actuator 20 can further comprise a magnet 23. The coil 21 is configured to generating a magnetic field when an electrical current is passed through the coil 21 to interact with a magnetic field of the magnet 23 so as to move the mover 22 along the optical axis A (i.e. in direction B or B′ depending on the direction of the electrical current flowing through the coil 21).

1. An optical device, comprising:
a first refractive element configured to refract incoming light, wherein the first refractive element comprises a first refractive index and a first surface for receiving a wavefront of said incoming light,
a second refractive element configured to refract light coming from the first refractive element, wherein the second refractive element is arranged adjacent the first refractive element such that a second surface is formed between the first refractive element and the second refractive element, via which second surface light can pass from the first refractive element to the second refractive element, and wherein the second refractive element comprises a second refractive index and a third surface for transmitting light coming from the first refractive element and passing through the second refractive element, and
wherein the refractive indices, and the shapes of the surfaces, depend on temperatures of the refractive elements and
wherein the refractive indices and the shapes of the surfaces, are adapted such that a shape of a wavefront of the transmitted light is independent of a temperature of the optical device, at a given total focal power, the drift of the total focal power due to a changing temperature is zero when said temperature lies within a pre-defined temperature range.

2. The optical device according to claim 1, wherein for adapting the first refractive index), the first refractive element is formed out of a corresponding first material, and wherein for adapting the second refractive index), the second refractive element is formed out of a corresponding second material.

3. The optical device according to claim 1, wherein the first refractive index) and the shape of the first surface) depend on the temperature.

4. The optical device according to claim 3, wherein the second refractive index varies less with temperature than the first refractive index), and wherein the shape of the second surface and the shape of the third surface each vary less with temperature than the shape of the first surface.

5. The optical device according to claim 1, wherein the second refractive index) and the shapes of the second surface and of the third surface each depend on the temperature.

6. (canceled)

7. (canceled)

8. The optical device according to claim 1, wherein the second surface comprises a curved shape.

9. The optical device according to claim 1, wherein the two refractive elements form a lens having a tunable focal length, wherein the first refractive element comprises a transparent liquid arranged between the first surface and the second surface, wherein the first surface is elastically deformable and comprises a shape having a tunable first radius depending on temperature, and wherein the second refractive element is rigid and forms the second surface which comprises a shape having a second radius, wherein the second radius is a fixed radius so that the liquid forms a bi-convex volume, and wherein the third surface comprises one of: a planar shape, a concave shape.

10. The optical device according to claim 9, wherein the shape of the first surface or of the second surface comprises a spherical and/or a cylindrical component.

11. The optical device according to claim 9, wherein the optical device comprises an actuator configured to tune the first radius.

12. The optical device according to claim 1, wherein for a given first refractive index), a given temperature-dependent first radius R1(T), and a planar wavefront of the incoming light, the second refractive index, the second radius and the third surface are adapted such that the wavefront of the transmitted light is independent of the temperature for a pre-defined focal power of the optical device when the temperature is within the pre-defined range.

13. The optical device according to claim 1, wherein the first refractive index exhibits a stronger temperature dependence than the second refractive index.

14. The optical device according to claim 1, wherein the first material comprises a general volumetric thermal expansion coefficient that is larger than the general volumetric thermal expansion coefficient of the second material.

15. The optical device according to claim 1, wherein the first refractive index is lower than or equal to the second refractive index.

16.-19. (canceled)

20. Optical device according to claim 9, wherein the optical device comprises a lens shaper contacting a transparent and elastically deformable membrane of the optical device, wherein the first surface is formed by a central portion of a surface of the membrane, wherein said portion of the surface of the membrane is defined by the lens shaper.

21. Optical device according to claim 11, wherein the actuator is configured to act on the membrane to tune the first radius wherein the actuator is configured to move a mover of the actuator along an optical axis of the optical device, wherein the mover is connected via a connecting structure to the lens shaper to move the lens shaper along the optical axis to adjust the first radius of the first surface and therewith the focal power of the optical device.

22. (canceled)

23. (canceled)

24. Optical device according to claim 20, wherein the actuator is configured to act on the membrane to tune the first radius wherein the actuator is configured to move a mover of the actuator along an optical axis of the optical device, wherein the mover is connected via a connecting structure to the lens shaper to move the lens shaper along the optical axis to adjust the first radius of the first surface and therewith the focal power of the optical device.
